(19) United States
(12) Patent Application Publication
(10) Pub. No.: US 2021/0100711 A1
(43) Pub. Date: Apr. 8, 2021

(54) Inversion Table Ankle Holder with Primary and Secondary Lock

(71) Applicants: Jackson Hsieh, City of Industry, CA (US); Donrobert Pena, City of Industry, CA (US)

(72) Inventors: Jackson Hsieh, City of Industry, CA (US); Donrobert Pena, City of Industry, CA (US)

(73) Assignee: Paradigm Health and Wellness, City of Industry, CA (US)

(21) Appl. No.: 16/856,335

(22) Filed: Apr. 23, 2020

Related U.S. Application Data
(60) Provisional application No. 62/910,339, filed on Oct. 3, 2019.

(51) Int. Cl. A61H 1/02

(52) U.S. Cl. CPC A61H 1/0229; A61H 2201/1642

(57) ABSTRACT

Improvements in an inversion table leg restraint lock. The restrain has a primary and a secondary lock to restrain the ankles of a user to allow the user to invert their body while they lay on a table or bed. The primary lock is a rod connected to a pin. The knob can be easily accessible by a user when they “lean over” to grasp the arm. The telescoping tube is connected to a pin that that lifts a pin from a track. The secondary lock is deactivated when a user places pressure on the foot rest, as when a user stands onto the foot rest as they enter onto the inversion table. Both the primary and secondary locks must be deactivated to allow for movement between ankle restraining pads and a foot roller.

### CROSS REFERENCE TO RELATED APPLICATION

This application claims the benefit of Provisional Application Ser. No. 62/838,212 filed Apr. 24, 2019 and Provisional Application Ser. No. 62/910,339 filed Oct. 11, 2019 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in an inversion table ankle holder. More particularly, the inversion table pop pin ankle holder has a primary and a secondary lock that uses an ankle lock that relies upon a manually controllable primary lock and a secondary lock that is controlled by body weight or position on a foot rest.

### Description of Related Art Including Information Disclosed Under 37 CFR 1.97 and 1.98

Inversion tables have been used for many years by people to reduce back pain and to stretch the spine. Inversion tables are essentially beds, tables or a cloth covered frame. The table is secured to a frame across the mid-section of the table to allow the table to pivot across the mid-section. At one end of the table is a retention mechanism for securing the ankles of a user. The retention mechanism can take a variety of forms, and one common form is with movable front ankle pads that are controlled with a handle that opens and closes the leg/ankle restraint. A pole is lifted, pushed or otherwise articulated to allow for movement of opening and closing the ankle pads. One problem with the leg/ankle restraint is that the mechanism can dislodged when a person is inverted therefor the ankles can be released.

A number of patents and or publications have been made to address these issues. Exemplary examples of patents and or publication that try to address this/these problem(s) are identified and discussed below.

U.S. Pat. No. 5,718,660 issued on Feb. 17, 1998 to Paul Chen is titled Exerciser for Straightening Spinal Column. This patent discloses an extension that is slidably engaged in the base and has one end extended outward of the base and has a clamping device for clamping the feet of the user to the extension. A bracket is secured to the extension. A lever is pivotally coupled to the base and a handle is secured to the lever for rotating the lever. This patent only uses a single locking mechanism to ensure that the lower legs of a user are restrained.

U.S. Pat. No. 6,814,691 issued on Nov. 9, 2004 to Chung Jen Kuo is titled Secure Mount for a Body Inversion Exerciser. This patent discloses a leg restraint that pivots and is secured with a rod that maintains the ankle restraints in a closed position. There is only one closed position. This mechanism does not account for users with different ankle sizes.

U.S. Pat. No. 7,077,795 issued on Jul. 18, 2006 to Shi-Lin Chen is titled Feet-Binding Apparatus for a Tilting Inversion Exercise Machine. This patent discloses an adjusting device, a control device, and an ankle holder. The adjusting device is connected to the tilting inversion exercise machine. The mechanism in enclosed with a cover that slides over the back housing. Using this mechanism, a user can accidentally release the feet-binding apparatus while inverted.

U.S. Pat. No. 9,089,468 issued on Jul. 28, 2015 to Lo Pin Wang is titled Tilting Inversion Exerciser Having Safety Foot Retaining Device. This patent discloses a foot rest attached to an extension of the table, a carrier is attached to the extension, and a foot retaining device having a lever pivotally attached to the carrier, a foot anchor device attached to the lever and movable toward and away from the foot rest of the extension, a latch member is attached to the lever for engaging with the carrier and for adjustably anchoring the lever and the foot anchor device to the foot rest of the extension at a selected angular position. The lever provides only a single locking mechanism to ensure that the legs are restrained and does not utilize the position or inversion of the user to control the lock.

What is needed is inversion table ankle holder with a primary and a secondary lock. The primary and secondary pins prevent releasing the ankle pads when the weight is not on a foot rest. The inversion table ankle holder disclosed in this document provides the solution.

### BRIEF SUMMARY OF THE INVENTION

It is an object of the inversion table ankle holder with a primary and a secondary lock to restrain the ankles of a user to allow the user to invert their body while they lay on a table or bed. When a person is inverted retaining their ankles is critical for safety. While a single lock provides some level of security the second lock provides a second mechanism that cannot be overcome accidentally thereby overriding the primary locking mechanism. The second lock is essentially activated or deactivated based upon the user's orientation when on the inversion table.

It is an object of the inversion table ankle holder with a primary and a secondary lock to have the ankle restraining pads to be pulled into a closed orientation with a spring. The spring maintains some pressure on the ankles of the user when the locks are opened. This allows a user to release the primary and secondary lock and the front ankle pad to close the pads onto the top of the lower leg.

It is an object of the inversion table ankle holder with a primary and a secondary lock to have a primary lock that gives a user a knob on a handle to adjust the desired ankle grip or compression. The primary lock is a rod connected to a pin. The knob can be easily accessible by a user when they “lean over” to grasp the arm of the knob. A telescoping tube is connected to a pin that is lifted from a track. The pin is biased into a hole with a spring.

It is another object of the inversion table ankle holder to have a pin that is guides though and “L” shaped follower. The “L” shape reduces the possibility that the pin can be vertically moved when not desired. The pin can also be moved under a covering tab to provide a visual indication when the ankle holder is securely locked or unlocked when a use is on the inversion table.

It is another object of the inversion table ankle holder to have a pin that passes completely through an inner and an outer tube that locks the distance between the ankle holders. Using a pin that passes completely through both tubes increases the security of the locking mechanism and also provides a longer travel on the pin to make it easier for a user to determine if the ankle holder is properly secure.

It is still another object of the inversion table ankle holder with a primary and a secondary lock to have a secondary lock. The secondary lock is deactivated when a user places pressure on the foot rest, as when a user stands onto the foot rest, as they enter onto the inversion table. The second lock can also be deactivated by depressing the foot rest manually. The second lock also uses a pin in a plurality of holes that is biased into one of the holes by a spring. When a user is inverted, their body weight translates their feet away from the foot rest, thereby engaging the second lock. When the user returns to a more upright orientation gravity will slide the user and their feet onto the foot rest and disengages the secondary lock.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of an inversion table pop pin ankle holder with a primary and a secondary lock.

FIG. 2 shows a perspective view of the pop pin ankle holder with a primary and a secondary lock on the extendable leg of the inversion table.

FIG. 3 shows a right-side view as a user stands on the inversion table of the pop pin ankle holder with a primary and a secondary lock on the extendable leg.

FIG. 4 shows a perspective vertical sectional view of the pop pin ankle holder with a primary and a secondary lock on the extendable leg.

FIG. 5 shows a perspective vertical sectional view of the primary lock.

FIG. 6 shows a perspective vertical sectional view of the secondary lock.

FIG. 7 shows a vertical perspective sectional view of the secondary lock.

FIG. 8 shows a vertical perspective view of the primary and secondary locks with the pins and rack.

FIG. 9 shows a perspective view of an alternate embodiment of the locking mechanism.

FIG. 10 shows a perspective sectional view of an alternate embodiment from the previous figure.

FIG. 11 shows a perspective view of another alternate embodiment.

FIG. 12A shows a detail view of the embodiment shown in the previous figure.

FIG. 12B shows the pin in a safe condition

FIG. 12C shows the pin in an unsafe condition.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Item Numbers and Description

| | |
|---|---|
| 19 inversion table | 20 elongated post/length adjustment tube |
| 21 inversion table or bed | 22 side arm grip tubes |
| 23 extended leg | 24 extended leg |
| 25 heel cup | 26 ankle roller |
| 26A moved ankle roller | 27 balance axis |
| 28 tube | 29 knob |
| 30 ankle securing mechanism | 31 foot rest |
| or holders | |
| 31A moved foot rest | 32 tube |
| 33 bolt hole | 34 bolt hole |
| 35 foot plate | 36 ankle cup |
| 37 “L” slot | 38 guide barrel |
| 39 bolt | 40 primary |
| 41 vertical tube | 42 inner tube rack |
| 43 outer tube | 44 knob |
| 44A moved knob | 45 spring |
| 46 spring | 47 pin |
| 48 holes | 49 shoulder |
| 50 hole spacing | 51 hole spacing |
| 52 offset | 53 covered tab |
| 54 pin | 60 secondary |
| 61 lower tube | 62 lower inner tube |
| 63 travel slot | 64 bolt |
| 65 spring | 67 pin |
| 67A moved pin | 68 holes |
| 69 plate | 90 pulling |
| 91 distance | 92 move |
| 95 down | 96 move |

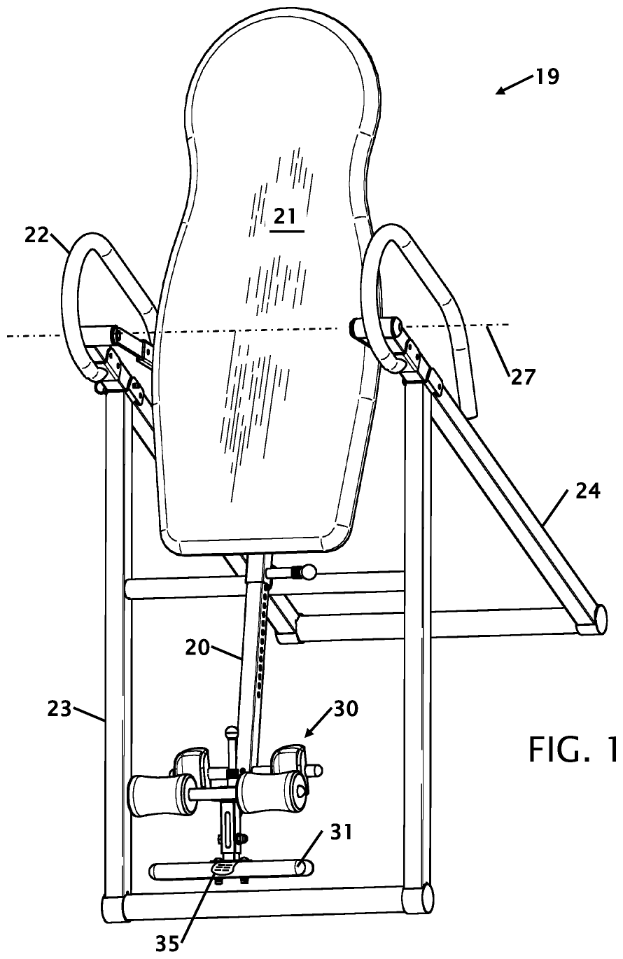

FIG. 1 shows a perspective view of an inversion table 19 pop pin ankle holder with a primary and a secondary lock with cushioned ankle holders 30 and with the ankle holding mechanism in the closed or clamped orientation. In this figure, the inversion table surface 21 is shown in an initial orientation in a slight reclined position. The inversion table 21 rotates on pivots within the balance axis 27. The inversion table 21 is supported on open or extended legs 23 and 24 that can be hinged together to reduce the storage size of the inversion table 19. Side arm grip tubes 22 allow a person to assist in inclining and declining the inversion bed 21 on the pivot or balance axis 27.

The ankle securing mechanism 30 is located on an elongated post 20 that is adjustably secured in the bottom of the table 21. The elongated post 20 is adjustable to locate a balance point that is unique for people having different heights and body mass distribution. A user will step on foot rest 31 or the foot plate 35 thereby disengaging the secondary lock, then the users will pull on primary 40 and disengage the primary lock in order to increase the distance between tubes 28 and 32.

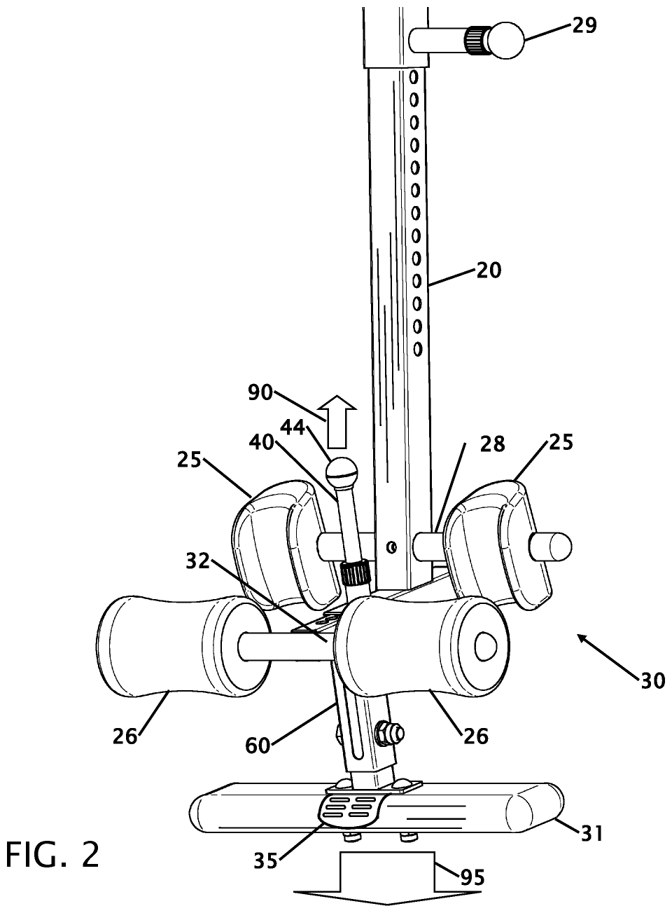

FIG. 2 shows a perspective view of the pop pin ankle holder with a primary 40 and a secondary 60 locks used in the ankle securing mechanism 30 on the extendable leg of the inversion table. The ankle securing mechanism is connected to a length adjustment elongated post 20 that is controlled with a spring-loaded rod that terminates with a knob 29 that is pulled (by a user) to dislodge a pin that engages into at least one hole with the elongated post 20. The ankle holders have heel cups 25 that cup or surround a portion of the back of a lower leg and a front ankle roller 26 that grasps the front of the lower leg. The heel cups 25 are connected with a connecting tube 28 that allows the heel cups 25 to pivot. The foot extends under the rounded front of the ankle roller 26. There are two ankle rollers 26 that are connected with a tube 32. The ankle rollers 26 and tube 32 assembly can also be completely removed and replaced with heel cups or other ankle retaining pads.

The primary 40 locking mechanism is controlled by pulling 90 on the spring-loaded knob 44, while the secondary 60 locking mechanism is controlled by stepping down 95 on the spring-loaded foot rest 31. The closing mechanism is controlled when a user lifts 90 the primary 40 locking mechanism while the user places body weight on the foot rest 31 to extend the foot rest 31 or the foot plate 35 down 95 to release the second 60 locking mechanism. The closing mechanism is shown and described in more detail with other cross-sectional figures herein.

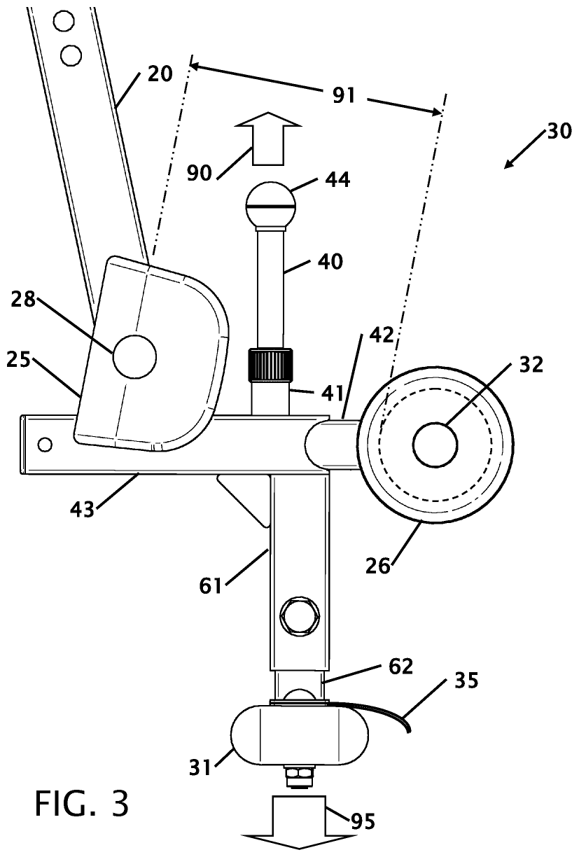

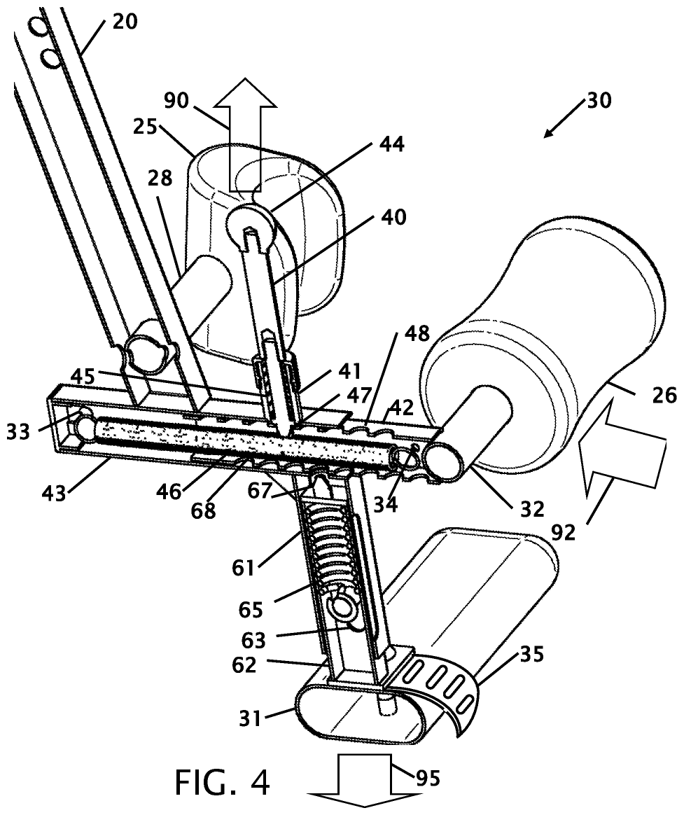

FIG. 3 shows a right side view as a user stands on the inversion table of the pop pin ankle holder with a primary 40 and a secondary lock 60 on the extendable leg 20 and FIG. 4 shows a perspective vertical sectional view of the pop pin ankle holder with a primary 40 and a secondary lock 60 on the extendable leg 20. Near the bottom of the extendable leg 20 is a tube 28 that supports the heel cups 25 at the outer sides of the tube 28. The heel cups on the tube 28 can pivot to accommodate the position and physical characteristics of a user. At the bottom of the extendable leg 20, an outer tube 43 is welded or otherwise secured. Within the outer tube 43 is an inner tube rack 42 that telescopes or slides within the outer tube 43. While heel cups 25 and ankle rollers 26 are shown and described, the lower leg restraint alters the distance 91 between the surfaces created by the heel cups 25 and the ankle rollers 26.

A spring 46 within the outer tube 43 and the inner tube rack 42 pulls the inner tube rack 42 into the outer tube 43 to move 92 the ankle roller 26. The spring 46 is secured at a first end with a bolt that passes through the spring 46 end and then through bolt hole 34, and at a second end with a bolt that passes through the spring 46 end and through bolt hole 33. At the top of the outer tube 43 is a vertical tube 41. There is a control rod for the primary 40 locking mechanism that as user can control at any position of table rotation. A spring 45 biases the pin 47 into at least one hole 48 in the inner tube rack 42. A knob 44 at the top of the primary 40 locking mechanism that the user can pull 90 to disengage the primary lock.

At the end of the inner tube rack 42 a tube 32 is welded or otherwise secured and the tube 32 supports ankle rollers 26 at the outer sides of the tube 32. An outer lower tube 61 is Welded or otherwise secured to the bottom of the outer tube 43. Within the outer lower tube 61 is a telescoping lower inner tube 62, and at the bottom of the lower inner tube 62 a horizontally mounted foot rest 31 is secured.

The secondary lock 60 is controlled by the user pushing down 95 on the foot rest 31. A spring 65 within the lower tube 61 and the lower inner tube 62 biases the secondary lock 60 into a locked position whereby the pin 67 engages into at least one hole 68 in the inner tube rack 42. When the user's feet press down 95 on the foot tube 31, or the foot plate 35, the lowering of the foot rest will unlock the secondary lock 60 by disengaging the pin 67 from one hole 68 in the inner tube rack 42. A travel slot 63 restricts or limits the overall travel of the foot rest 31. While a pin 67 is shown engaging into a hole 68, this can also be with a tang or tab that engages into a slot or an equivalence therein.

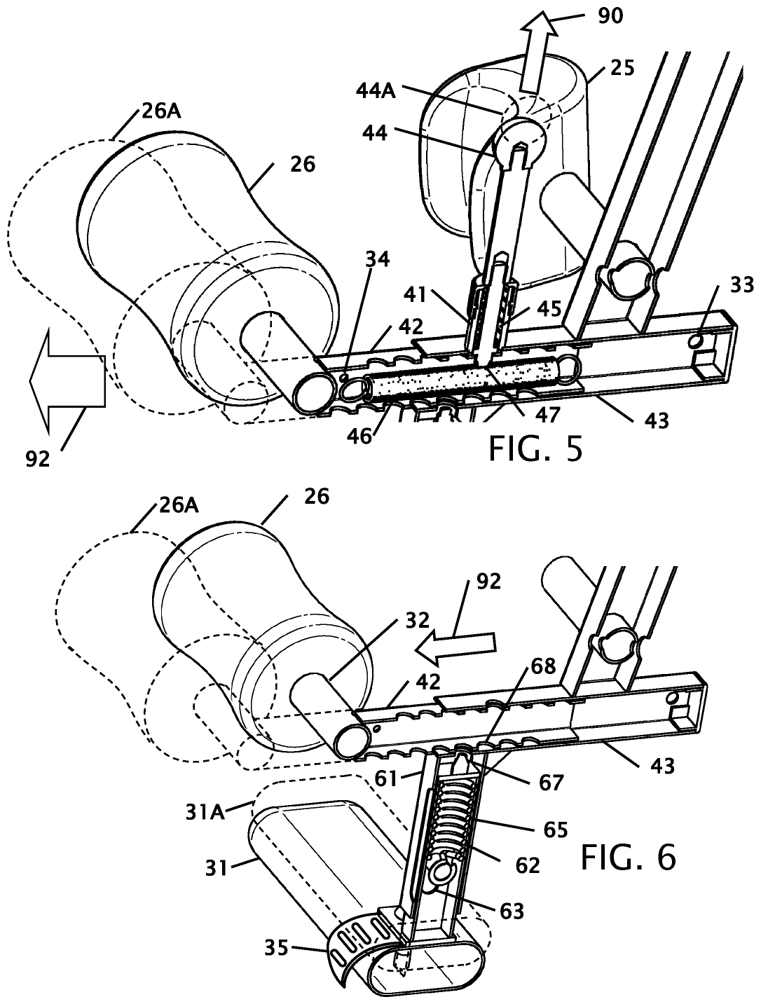

FIG. 5 shows a perspective vertical sectional view of the primary lock. This view shows the ankle roller 26 in a partially retracted position and in a partially expanded position 26A. The spring 46 is secured and connects between at opposing ends with fasteners (not shown) through holes 33 and 34 that pull the ankle roller 26 into closer proximity to the heel cup 25 as the inner tube rack 42 slides within the outer tube 43. A user can move 92 the ankle roller 26 by over coming the tension of the spring 46. This is typically accomplished by the feet of a user when the user is in the inversion table or can be accomplished by manually pulling the ankle roller when the primary and secondary locks are retracted.

The primary lock is shown as the pin 47 is engaged in the inner tube rack 42. The spring 45 within the vertical tube 41 pushes the pin 47 into the opening in the inner tube rack 42. A user can withdraw the knob 44 by pulling 90 upon the knob 44A to overcome the spring 45 forces that holds the pin 47 in the inner tube rack 42.

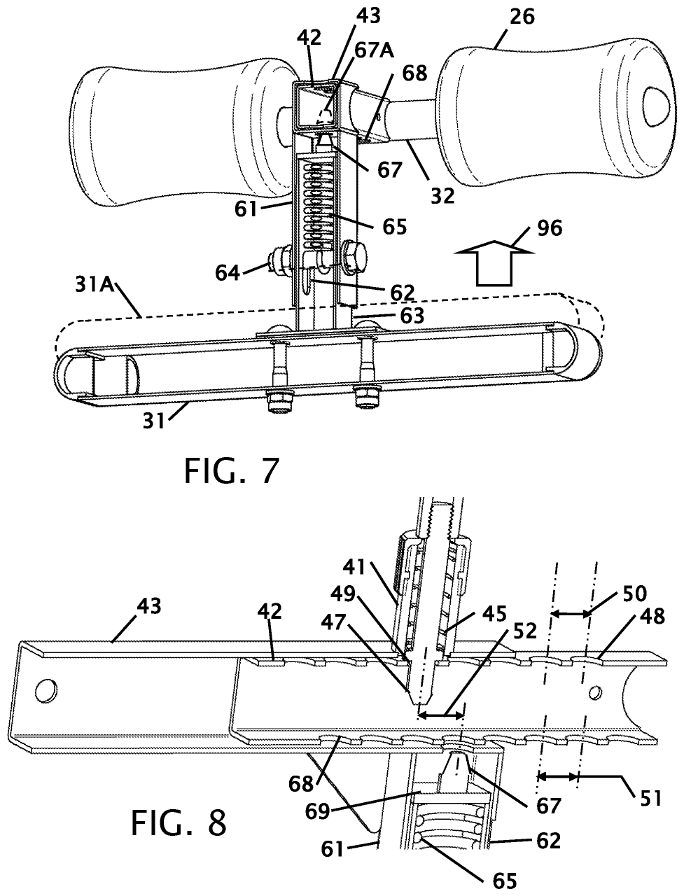

FIG. 6 shows a perspective vertical sectional view of the secondary lock and FIG. 7 shows a vertical perspective sectional view of the secondary lock. In these views some components have been removed for clarity. The ankle rollers 26 are shown in two positions extended 26 and extended at 26A. The inner tube rack 42 shows 8 possible holes 68 where the inner tube rack 42 can be located in the outer tube 43. While 8 positions are shown where the pin 67 can engage into hole(s) 68 in the inner tube rack 42 it should be understood that more or less than the 8 positions are possible. In FIG. 7 the pin 67 is shown in a retracted and extended orientation 67A where the pin is engaged into one of the eight position holes 68.

The pin 67 is biased with spring 65 to hold the pin 67 in a hole 68. The foot rest 31 is secured to the lower inner tube 62 that telescopes within the outer lower tube 61. The position of the pin 67 is withdrawn from a hole 68 when sufficient force is applied onto the foot rest 31 to overcome the spring 65 force. This is typically accomplished when a user enters onto the inversion table and stands upon the foot rest 31 or steps down on the foot plate 35. As the inversion table rotates into the inverted orientation gravity forces will no longer be applied to the user's foot on the foot rest 31A and the spring 65 will move 96 the foot rest 31 to push the secondary lock pin 67 into a hole 68. This will prevent the ankle roller 26 on the tube 32 from moving 92 regardless of the position of the primary lock. An oval or rectangular travel slot 63 restricts the overall travel of the foot rest 31 as the bolt 64 moves within the travel slot 63. The bolt 64 is shown secured to one end of the spring 65, while the opposing end of the spring 65 is engaged onto a plate on the underside of pin 67.

FIG. 8 shows a vertical perspective view of the primary and secondary locks with the pins and rack. In this figure many components have been removed to show the interaction between the primary and secondary locks and their interaction with the inner tube rack 42 as it moves within the outer tube 43. The primary lock is shown with the pin 47 entering into a hole 48 in the top of the inner tube rack 42. The secondary lock is shown with the pin 67 entering into a hole 68 in the bottom of the inner tube rack 42.

The primary lock has the pin 47 that is biased by spring 45 that pushes the pin 47 in vertical tube 41 into the hole 48 in the inner tube rack 42. A shoulder 49 on the pin 47 limits the travel of the pin 47 into the hole 48. The secondary lock has a pin 67 that is biased by spring 65 that pushes the pin 67 on lower inner tube 62 into the hole 68 in the inner tube rack 42 as the lower inner tube 62 moves within the lower tube 61. A plate 69 on the pin 67 limits the travel of the pin 67 into the hole 68. Both the primary lock and the secondary lock must be disengaged with pins 47 and 67 withdrawn from the holes 48 and 68 in the inner tube rack 42 to adjust the lower leg restraint.

In this figure the pin 67 is shown as a stepped pin that will self-locate into a hole 68 to lock the leg roller if the user does not properly engage the primary locking mechanism. It is also contemplated that the pin can have a rounded or conical tip to engage the pin in the hole. The pin 67 could also have a flat end or be angled like a ratchet to allow for one-direction of travel if the secondary locking mechanism is not displaced.

The inner tube rack 42 shows 8 possible holes 68 and holes 48 in the inner tube rack 42 where the inner tube rack 42 can be located within the outer tube 43. While 8 positions are shown where the pin 67 can engage into hole(s) 68 in the inner tube rack 42 it should be understood that more or less than the 8 positions are possible. The distance 50/51 between the holes is selected to provide finite increments between the ankle roller 26 and the heel cups 25 (neither shown in this figure). This figure also shows an offset 52 between the centerlines of pins 47 and 67. The offset 52 is selected based upon the distance between the back of a user's ankles and a comfortable location for a root rest.

In another contemplated embodiment the secondary locking mechanism can rely upon an angular position of the inversion bed. In this embodiment when the angle of the inversion bed passes through an angle or about horizontal, the pin in the secondary locking mechanism will move into the inner tube rack. When the angle of the inversion table passes back through the defined angle the secondary locking mechanism will disengage to allow for full control of just the primary locking mechanism.

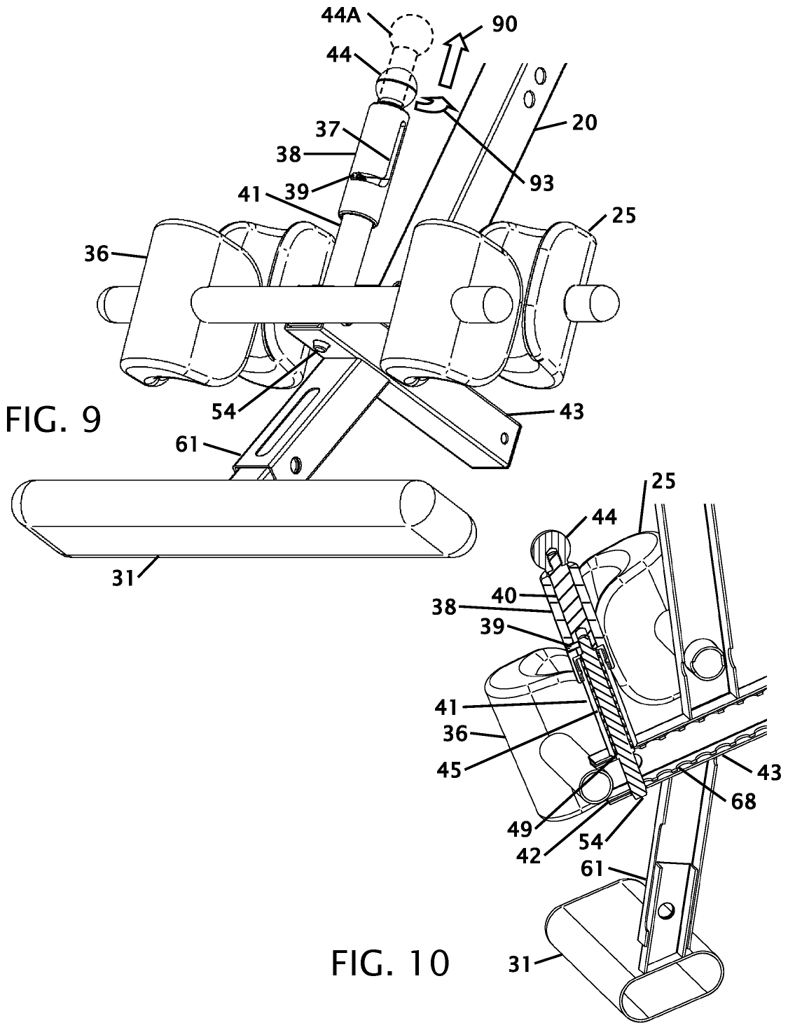

FIG. 9 shows a perspective view of an alternate embodiment of the locking mechanism at the end of the elongated post 20 and FIG. 10 shows a perspective sectional view of this alternate embodiment. In this embodiment the pin 54 is elongated and passes through a first side of the outer tube 43 through indexing holes 68 in the inner tube 42 and out the bottom of the outer tube 43. The pin 54 is retained within vertical tube 41 and a spring 45 biases the pin 54 through the inner tube 42 and the outer tube 43. A shoulder 49 on the pin 54 limits the travel of the pin 54 through the inner tube 42. The pin 54 is secured into the primary lock 40 within a guide barrel 38. The user accessed knob 44 is used to control the pin 54. While the knob 44 is shown as round, the knob 44 can be other shapes that give a user a greater ability to grasp or turn the knob 44.

The guide barrel 38 has an “L” slot 37. A bolt 39 follows the “L” slot 37. To remove the pin 54 from the hole 68, a user will rotate 93 the knob 44 to guide the bolt 39 to the vertical portion of the “L” slot 37 and then pull 90 the knob 44 to overcome the spring 45 force to move the knob to position 44A. While the slot 37 is shown as an “L” slot, the slot 37 could also be a “J”, upside-down “T” or other shape that the bolt 39 follows to properly engage and disengage the leg restraint. While the item 39 may be described as a bolt, it could be a pin, tube or other follower. Once the pin 54 is clear of the hole 68 the user can slide the inner tube 42 to adjust the distance between the heel cup 25 and the ankle cup 36.

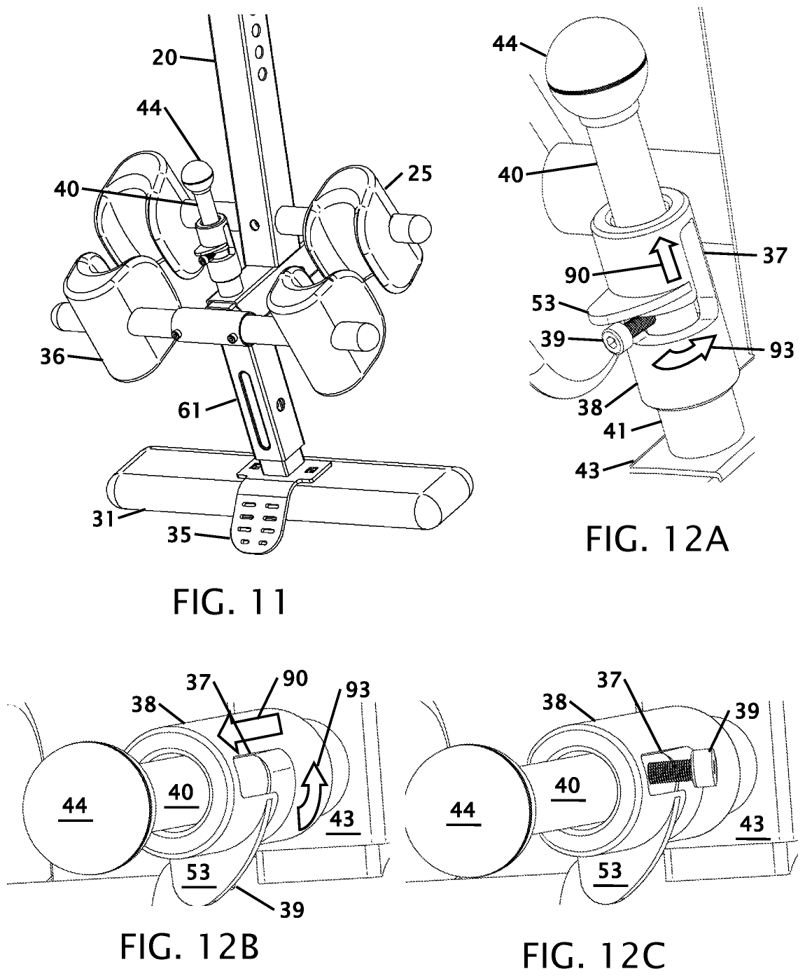

FIG. 11 shows a perspective view of another alternate embodiment of the locking mechanism at the end of the elongated post 20, FIG. 12A shows a detail view of the embodiment shown in the previous FIG. 12B, showing the pin in a safe condition and FIG. 12C showing the pin in an unsafe condition. In this embodiment the primary lock 40 is within a guide barrel 38. The user accessed knob 44 is used to control the primary lock 40. While the knob 44 is shown as round, the knob 44 can be other shapes that give a user a greater ability to turn the knob 44.

The guide barrel 38 has an “L” slot 37. A bolt 39 follows the “L” slot 37. To remove the pin 54 from the hole 68, a user will rotate 93 the knob 44 to guide the bolt 39 to the vertical portion of the “L” slot 37 and then pulls 90 the knob 44 to overcome the spring 45 force to move the knob. While the item 39 may be described as a bolt, it could be a pin, tube or other follower. In this embodiment, a covering tab 53 is used to provide a visual indicator of the lock position. When the bolt 39 is visible, from the perspective of a user on the inversion table looking down at their ankles, the unit is in an unsafe condition, whereas when the bolt is not visible, because it is covered by the covering tab 53, the inversion table is in a safe condition. This is more clearly shown in FIGS. 12C and 12B respectively. Once the pin 54 is clear of the hole 68 the user can slide out the inner tube 42 from the outer tube 43 to move the ankle cups 36 to change the distance between the ankle cups 36 and the heel cups 25. As previously described, the user can stand on the foot rest 31 or can press down on the foot plate 35 to extend the location of the foot rest 31 from the lower tube 61.

Thus, specific embodiments of a ratchet cover for an inversion table have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. An inversion table ankle holder with a primary and a secondary lock comprising:
an inversion table;
said inversion table having an ankle securing mechanism;
said ankle securing mechanism having a primary lock consisting of a pin that engages into at least one hole in a rack, and
said ankle securing mechanism having a secondary lock that is operated based upon pressure on a foot rest.

2. The inversion table ankle holder with a primary and a secondary lock according to claim 1, wherein both said primary lock and said secondary lock are disengaged to adjust said ankle securing mechanism.

3. The inversion table ankle holder with a primary and a secondary lock according to claim 1, wherein said ankle securing mechanism consists of heel cups, ankle rollers or a combination thereof.

4. The inversion table ankle holder with a primary and a secondary lock according to claim 1, wherein said ankle securing mechanism is a distance between two securing surfaces.

5. The inversion table ankle holder with a primary and a secondary lock according to claim 1, wherein said second lock is engaged when said inversion table is rotated.

6. The inversion table ankle holder with a primary and a secondary lock according to claim 1, wherein said second lock has a spring that biases said second lock to a locked condition.

7. The inversion table ankle holder with a primary and a secondary lock according to claim 6, wherein said spring engages a pin into a hole or a tang into a slot.

8. An inversion table ankle holder with a primary and a secondary lock comprising:
an inversion table;
said inversion table having an ankle securing mechanism;
said ankle securing mechanism having a primary lock consisting of a pin that engages into at least one hole in a rack, and
said ankle securing mechanism having a secondary lock that is operated based upon an angle of said inversion table.

9. The inversion table ankle holder with a primary and a secondary lock according to claim 8, wherein both said primary lock and said secondary lock are disengaged to adjust said ankle securing mechanism.

10. The inversion table ankle holder with a primary and a secondary lock according to claim 8, wherein said ankle securing mechanism consists of heel cups, ankle rollers or a combination thereof.

11. The inversion table ankle holder with a primary and a secondary lock according to claim 8, wherein said ankle securing mechanism is a distance between two securing surfaces.

12. The inversion table ankle holder with a primary and a secondary lock according to claim 8, wherein said second lock has a spring that biases said second lock to a locked condition.

13. The inversion table ankle holder with a primary and a secondary lock according to claim 8, wherein said spring engages a pin into a hole or a tang into a slot.

14. An inversion table ankle holder with a primary lock comprising:
an inversion table;
said inversion table having an ankle securing mechanism;
said ankle securing mechanism having a primary lock with a pin that tracks in an “L” shaped slot wherein said pin is rotated then withdrawn to allow said ankle securing mechanism to be opened or closed.

15. The inversion table ankle holder with a primary lock according to claim 14, wherein said primary lock is a pin that passes through an outer tube that is secured to one side of ankle supports and an inner tube that is secured to a second side of said ankle supports.

16. The inversion table ankle holder with a primary lock according to claim 14, wherein said primary lock is a pin that is secured at a first end to a pin, extends into said “L” shaped slot and has a head that extends out of at least a portion of said “L” shaped slot and further includes a covering tab that blocks view of said pin when said pin is in a secure setting where said ankle securing mechanism is locked.

17. The inversion table ankle holder with a primary lock according to claim 14, further includes a secondary locking mechanism.

18. The inversion table ankle holder with a primary lock according to claim 17, wherein said secondary lock is operated based upon pressure on a foot rest.

19. The inversion table ankle holder with a primary lock according to claim 18, wherein said second lock has a spring that biases said second lock to a locked condition.

20. The inversion table ankle holder with a primary lock according to claim 17, wherein said second lock is engaged when said inversion table is rotated.
